(19) United States
(12) Patent Application Publication
(10) Pub. No.: US 2010/0232909 A1
(43) Pub. Date: Sep. 16, 2010

(54) METHOD AND DEVICE FOR FINISHING A BOOK COVER

(76) Inventors: Henri Huotari, Espoo (FI); Iisakki Huotari, Helsinki (FI); Markku Siikamäki, Espoo (FI)

Correspondence Address: FAY SHARPE LLP, 1228 Euclid Avenue, 5th Floor, The Halle Building, Cleveland, OH, 44115, US

(21) Appl. No.: 12/162,167

(22) PCT Filed: Jan. 19, 2007
(86) PCT No.: PCT/FI2007/000019

§ 371 Date: May 20, 2010

(30) Foreign Application Priority Data
Jan. 25, 2006 (FI) 20060074

(51) Int. Cl. B42C 11/00; B42C 11/02

(52) U.S. Cl. 412/4; 412/19

(57) ABSTRACT

Method and device for folding the parts of the surface film (9) of a book cover (8), which protrude from the cover, onto the cover and attaching them to the inner surface of the cover. For this purpose, a device formed of two rollers (2, 3) is used. A gap is formed between the rollers, which is smaller than the thickness of the cover (8) being dealt with. At least one roller (3) is loaded by a spring towards the other roller (2). The cover (8) being dealt with, to which a surface film (9) is glued, in such a way that its edges protrude outside the edges of the cover, is brought against the surface of the other roller at an essentially slanting position, and the edge of cover is turned, while continuing to press it against the roller, between the rollers for at least the distance of the film folded against the inner surface of the cover takin it into the ressure of the rollers.

The present invention relates to a method and device for finishing a cover of a book or similar It relates particularly to a so-called hard cover.

Nowadays, book cover are usually made in such a way that the front cover and the back cover, as well as a piece of cover material or slightly thinner sturdy material acting as a support for the spine, are positioned as accurately as possible on a surface film with an adhesive surface.

Once the aforementioned pieces have been positioned in place and are secured preliminarily to the adhesive-surfaced film, the corners of the parts protruding beyond the cover pieces are cut away and the free part is folded onto the inside of the cover, to which it adheres. In the stage in which the interior of the book is attached in place, a further liner page of paper is glued to the inner surfaces of the covers.

In the case of the parts that protrude outside the covers after the first stage, the folding and attachment of the surface film can be performed entirely manually, or at that stage auxiliary devices can be used. In one of the applicant's previous inventions, after the first stage of gluing the cover pieces, the cover is pushed between and through two rollers.

The passage through the aforementioned rollers takes place as a movement in a straight line directly between the rollers, by pushing at their centre point. The drawback is that the surface film must be already folded to some extent in its final folding direction, so that the film will not crumple in the wrong way. All in all, there is a relatively large possibility for the loose film to become wrapped around the edge of the cover.

Another purpose of the rollers is that they press the surface film very tightly onto the cover material as it travels between the rollers. However, if the rollers are tightened with the aid of, for example, springs, a specific pressure that is sufficient for carrying out the work, against each other, it will be extremely difficult to make the cover go between the rollers by only pushing it. If, on the other hand, the tightening is left so loose that the cover goes easily between the rollers, the pressure may be insufficient.

The present invention is intended to create a solution to the problems described above and for thus create a device, which is easy to use and with the aid of which an equally good result will always be achieved.

The aforementioned and other advantages and benefits of the present invention are achieved by means of a method and device, the characteristic features of which are stated in the accompanying Claims.

In the following, the invention is examined in greater detail with reference to the accompanying drawings, which show one well-regarded embodiment of the invention.

Thus:

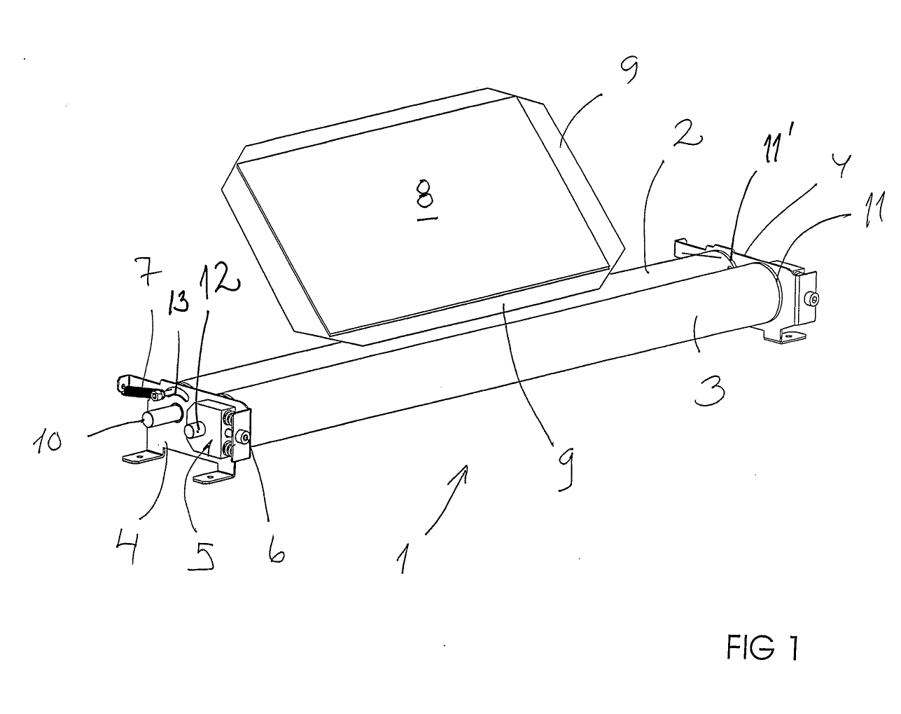

FIG. 1 shows an axonometric view of one embodiment of the invention;

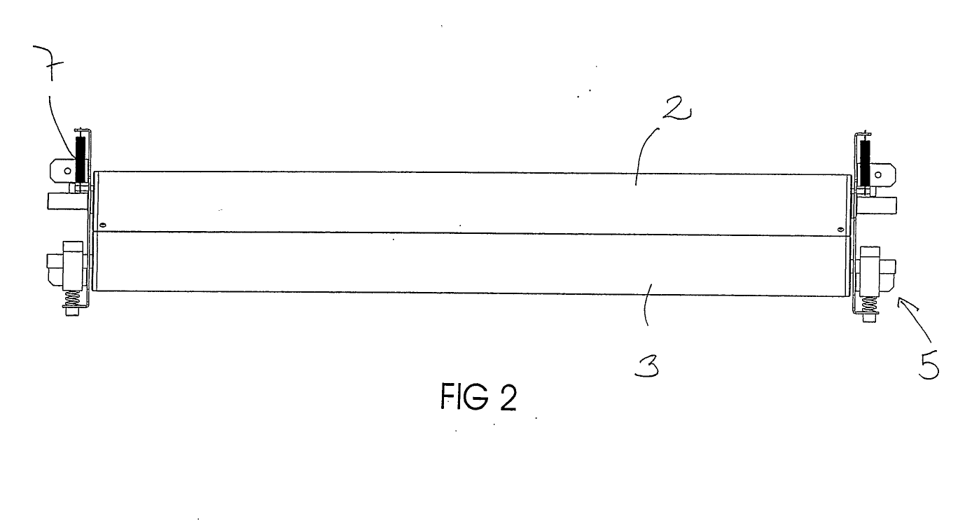

FIG. 2 shows a top view of the same device;

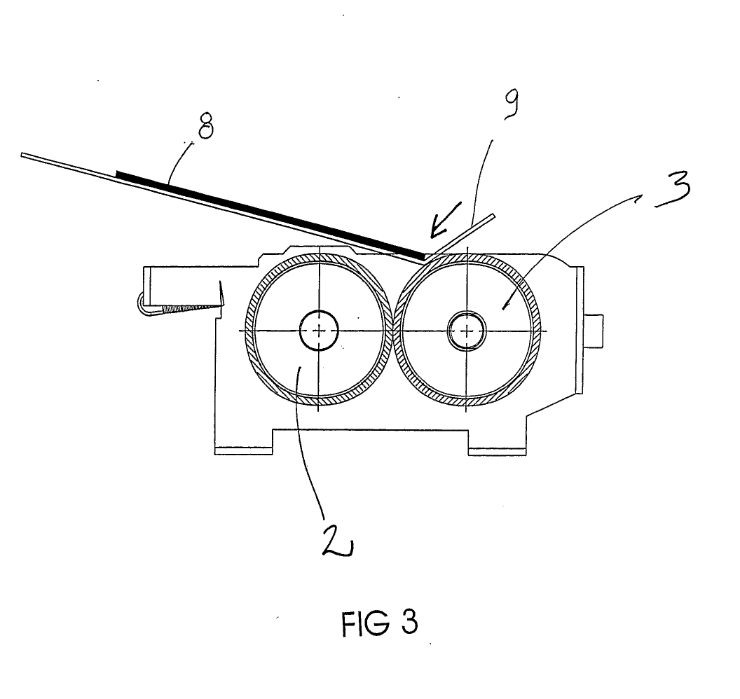

FIG. 3 shows the initial position of the book cover, in the stage when the surface film is begun to be folded onto the inner sides of the cover; and

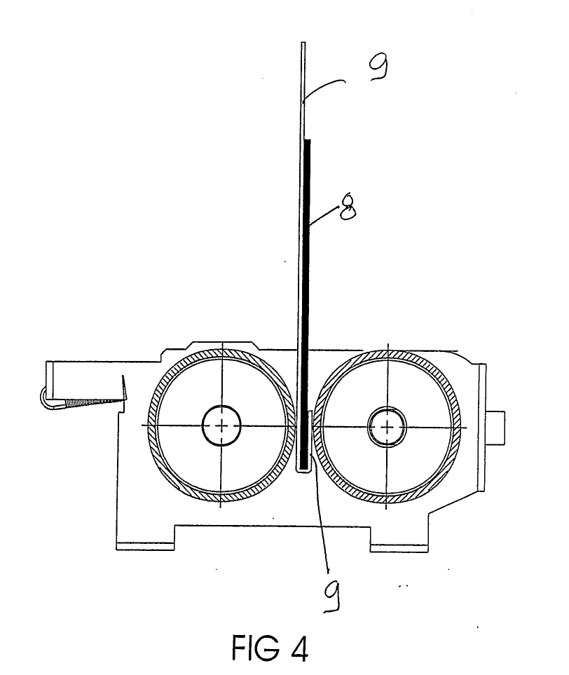

FIG. 4 shows the final stage of the folding.

The method according to the invention will be depicted in connection with the description of the device.

The features of the device shown in FIG. 1 are the following. The device 1 is formed of two rollers 2 and 3 attached to a frame 4, 4. In a conventional manner, the rollers have shafts 10 and 12, on which they are attached to the frame. The shaft 12 of the roller 3 is to some extent movable against the spring force caused by a spring device 5.

Although it may appear in the figures that the rollers lie tightly against each other, this is not the case, but instead there is a small gap between the rollers, which is defined by disc-like protrusions 11, 11′ located at the ends of the rollers, which when they come into contact with each other define the minimum distance between the rollers. Naturally, there are protrusions of this kind at both ends of the rollers.

As stated, the device includes a spring device at both ends of the roller 3, by adjusting the adjustment screws of which the roller 3 can be pressed to its extreme position with a specific force. In the device according to the invention, the force can be sufficiently great, because bringing the cover 8 between the rollers 2 and 3 is not a measure requiring excessive exertion, on account of the small gap between the rollers. In order to ensure and facilitate this, it is possible to add a lever (not shown) to the end of the shaft 10, by means of which the shaft 10, and at the same time of course the roller 2, can be rotated. The rotation helps the cover to be placed easily between the rollers at the start.

FIG. 2 shows a top view of the device of the invention, and as such does not require additional explanation.

The operation of the device according to the invention is as follows. it is shown in FIGS. 3 and 4, in which the structure of FIG. 1 is shown in cross-section more or less in the centre, and in any event at the cover 8 shown in FIG. 1.

Thus, referring to FIGS. 1 and 3, the process starts after the stage, in which the cover piece 8 is glued to the surface film 9, which protrudes over the edges of the cover 8 and from which the corners have already been cut off. The parts protruding from the cover have adhesive surfaces, so that the protruding part can be glued onto the inner side of the cover.

Unlike known methods, which were the manual folding of the film, or running the cover between two rollers in a straight direction, the method now comprises the work being commenced by bring the cover 8 with the surface film to the roller 3, more or less in the position shown in FIG. 3. The entire structure can be encased in such a way that the cover 8 can come within a small distance of a stop on the surface of the rollers at the same time as it is brought against the roller 3, particularly being pressed in a slanting position against the roller and being guided towards the gap between the rollers. Thus, the movement can be sliding along the surface of the roller 3, or the rollers can also be rotated by the movement, in which case the edge of the cover 8 will remain more or less in place on the surface of the roller 3.

At this stage, just enough force is used to ensure that the surface film 9 folded over the edge of the cover settles firmly against the edge of the cover. Additional folding of the film 9 is ensured by holding the edge of the cover the whole time tightly against the surface of the roller 3 when the cover is turned to the position shown in FIG. 4, in which the cover goes at least between the rollers to the extent of the folding edge part of the film, so that the pressure of the rollers will create firm adhesion.

After this, the cover is pulled away from between the rollers and is turned for the preparation of the next edge. The same series of operations is performed for each edge to be folded and thus the cover is finished.

FIG. 1 shows a further variation of the basic model. In this case, a spring 7, one end of which is attached to the frame structures and the opposite end to a pin, which is attached to the roller 2, and which is intended to move in a slot 13. Thus the extent of the rotation of the roller 2 is only the length of the slot 13, which is calculated to be sufficient to bring the edge to a folded/glued state. Particularly if the lever at the end of the shaft 10 is used to assist the entry of the cover between the rollers, the spring 7 will assist the roller to rotate back to its starting position without the lever needing to be turned backwards.

It is obvious that the invention can be varied in many ways, without nevertheless deviating from the inventive idea and the scope of protection of the accompanying Claims. The shapes and dimensions can vary even greatly from those shown, which depict only the most essentially necessary part of the total apparatus, in terms of the operation of the invention.

1. Method for folding the parts of the surface film (9) of a book cover (8), which protrude from the cover, onto the cover and attaching them to the inner surface of the cover, by using for this purpose a device formed of two rollers (2, 3), characterized in that
a gap is formed between the rollers, which is smaller than the thickness of the cover (8) being dealt with,
at least one roller (3) is spring-loaded towards the other roller (2),
the cover (8) being dealt with, to which the surface film (9) is glued in such a way that its edges protrude outside the edges of the cover, is brought against the surface of one roller at an essentially slanting position relative to it, at the same time pressing it against the roller, and
the edge of the cover is turned, while still pressing it against the roller, between the rollers to at least the extent of the film being folded onto the inner surface of the cover, taking it into the pressure of the rollers.

2. Method according to claim 1, characterized in that the transfer of the cover (8) to between the rollers (2, 3) is assisted by rotating a level located on the shaft of a roller.

3. Method according to claim 1, characterized in that each side of the cover is dealt with consecutively, in essentially the same way.

4. Device for folding the parts of the surface film (9) of a book cover (8), which protrude from the cover, onto the cover and attaching them to the inner surface of the cover, in which device there are two rollers (3, 4), characterized in that, in order to keep the rollers at a predefined distance to each other, there are in the device disc-like components (11) defining the gap, and that at least one roller (3) is equipped at both of its ends with a spring device (5), for pressing the roller towards the adjacent roller (2) with the aid of springs.

5. Device according to claim 4, characterized in that the gap between the rollers is smaller than the thickness of the cover (8) being dealt with.

6. Device according to claim 4, characterized in that the other roller (2) is equipped with a hand-operated handle, to assist rotation while the cover is being put between the rollers.

7. Device according to claim 4, characterized in that the extent of the rotation of the roller (2) is limited.
